(19) United States
(12) Patent Application Publication
(10) Pub. No.: US 2024/0415279 A1
(43) Pub. Date: Dec. 19, 2024

(54) Ultimate ping-pong table

(71) Applicant: Robert Alvord, Tualatin, OR (US)

(72) Inventor: Robert Alvord, Tualatin, OR (US)

(21) Appl. No.: 18/445,888

(22) Filed: Mar. 7, 2024

Related U.S. Application Data
(60) Provisional application No. 63/372,771, filed on Apr. 5, 2022.

(51) Int. Cl. A47B 25/00; F21V 23/00; F21V 23/02

(52) U.S. Cl. CPC A47B 25/003; F21V 23/002; F21V 23/023

(57) ABSTRACT

Ping-pong-type table having a table with a playing surface, and four sets of full spectrum lights adaptable to be independently controlled by a user via a phone application, the table designed for resting on one or more existing other tables, wherein the lights allow a user to vary and control the color appearance of the playing surface, the end lines, the side lines, and the center lines via a phone application.

### RELATED APPLICATION

This is an originally-filed US Non-provisional Patent Application.

### FIELD OF INVENTION

This invention relates to ping-pong tables, but it is not a ping-pong table as is traditionally conceived, as the invention does not have legs, and more particularly the invention comprises lights as a part thereof.

### BACKGROUND OF THE INVENTION

None of the prior patents found (listed below) allow for four separate light colors.

Patent numbers of prior art found: U.S. Pat. No. 7,250,013, to Hao, for Detachable Table Tennis Apparatus; U.S. Pat. No. 9,519,184, assigned to Samsung Electronics Co., LTD, for Backlight Unit; and U.S. Pat. No. 9,970,651, assigned to Import Direct, Inc., for Furniture With LED Light Arrangement.

None of the patents found have the concept of four separate light colors presented with a ping-pong table-top.

### SUMMARY

This invention lies upon any table the customer has. Thus, the Ultimate Ping-Pong Table can be customized to any size the customer wishes.

There are two halves to the table: each half has two separate sets of lights: One set is for the sidelines, center line and end line, which are typically white, and in the drawings are called the “Outer Lights.” One set is for the playing field, which is typically green or blue, and in the drawings are called the “Inner Lights.” Both sets of lights are independently controlled via an application, and, thus, the entire table can be configured to have four separate colors (see example in FIG. 3).

These lights are adjustable in color, hue, and intensity.

### BRIEF DESCRIPTION OF THE DRAWINGS

FIG. 1 shows a side view of one-half of an Ultimate Ping-Pong Table in accordance with an aspect and embodiment of the invention-only half is shown for simplicity, and as each half is the same;

FIG. 2 shows a top view of one-half of an Ultimate Ping-Pong Table of further in accordance with an aspect and embodiment of the invention; and

FIG. 3 shows a top view of an example color set-up of an Ultimate Ping-Pong Table further in accordance with an aspect and embodiment of the invention.

### DETAILED DESCRIPTION

Referring to the Figs., this invention lies upon any table the customer has. Thus, the Ultimate Ping-Pong Table can be customized to any size the customer wishes. As such, the drawings do not have specific dimensions.

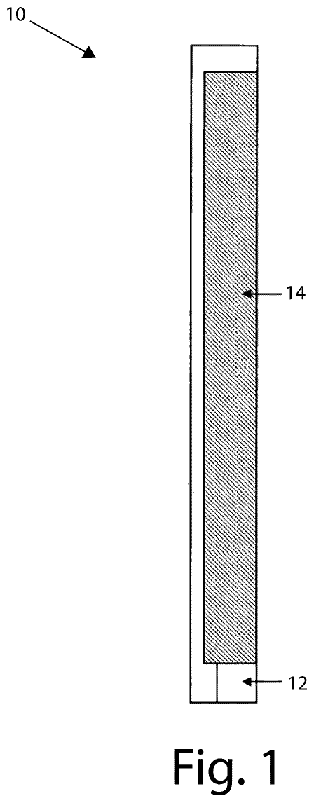

As shown in FIG. 1, a side view of one-half of an Ultimate Ping-Pong Table 10 in accordance with an aspect and embodiment of the invention-only half is shown for simplicity, and as each half is the same. The side view of the Ultimate Ping-Pong Table 10 shown in FIG. 1 comprises a power port 12 for power supply and lights 14.

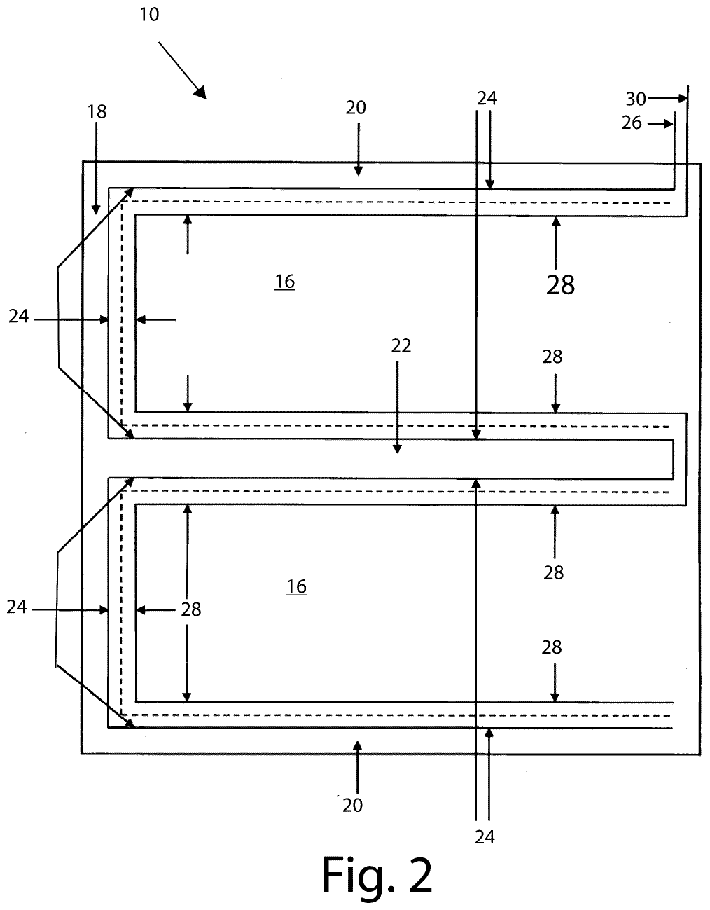

As shown in FIG. 2, there is shown a top view of one-half of an Ultimate Ping-Pong Table 10 further in accordance with an aspect and embodiment of the invention and showing two playing surfaces 16, delineated by an end line 18, two sidelines 20, and a center line 22. The Ultimate Ping-Pong Table 10 further comprises on its playing surfaces an outer lights line 24 connected via an outer power cord 26, and an inner lights line 28 connected via an inner power cord 30, all in accordance with an aspect and embodiment of the Ultimate Ping-Pong Table 10.

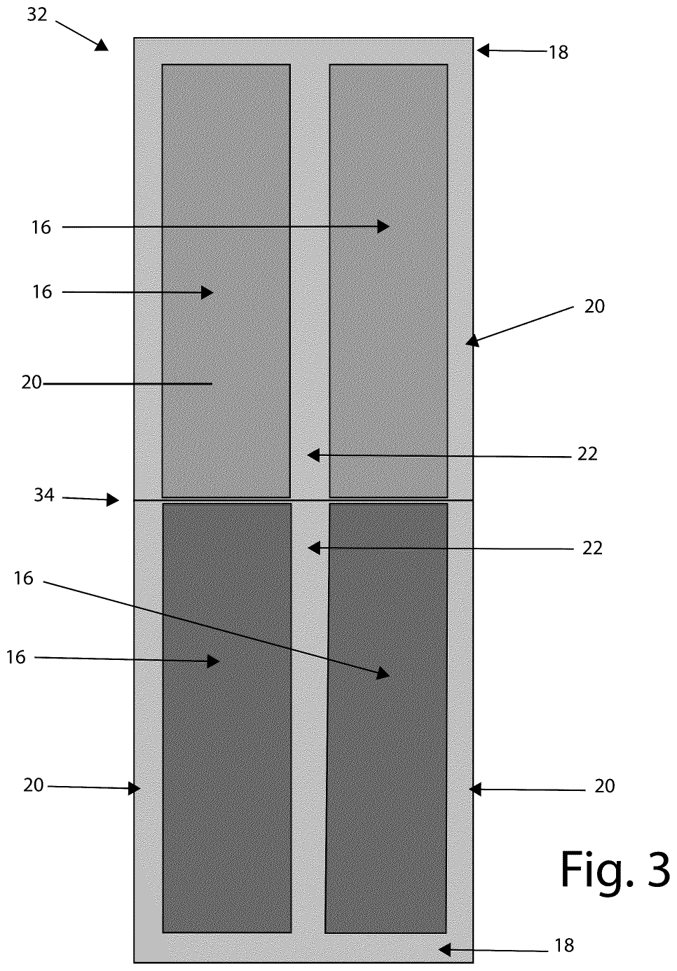

As shown in FIG. 3, a top view of an example color set-up embodiment of an Ultimate Ping-Pong Table 32 further in accordance with an aspect and embodiment of the invention, there are designated four playing surfaces 16 (since both halves of the Ultimate Ping-Pong Table are shown), each half being delineated by an end line 18, two sidelines 20, and a center line 22. There is also provided a net 34 between the two halves of the Ultimate Ping-Pong Table 32, as is customary with a traditional ping-pong table.

I claim:

1. (canceled)

2. A ping-pong-type table, comprising:
a table comprising a playing surface; and
a plurality of sets of full spectrum lights adaptable to be independently controlled by a user via a phone application.

3. The ping-pong-type table of claim 1, wherein the table is designed to be laid upon one or more existing tables.

4. The ping-pong-type table of claim 1, wherein the plurality of sets of full spectrum lights define end lines, side lines, and center lines on the table playing surface.

5. The ping-pong-type table of claim 3, wherein the plurality of sets of full spectrum lights allow a user to vary and control the color appearance of the playing surface, the end lines, the side lines, and the center lines.

6. The ping-pong-type table of claim 4, further comprising at least one of a power port for power supply, inner light power cords, and outer light power cords.
